(19) United States
(12) Patent Application Publication
(10) Pub. No.: US 2005/0217954 A1
(43) Pub. Date: Oct. 6, 2005

(54) Viscous isolation and damping strut utilizing a fluid mass effect

(76) Inventors: Timothy A. Hindle, Phoenix, AZ (US); James H. Boyd, Phoenix, AZ (US); David A. Osterberg, Glendale, AZ (US); Tristram T. Hyde, Severna Park, MD (US)

Correspondence Address: HONEYWELL INTERNATIONAL INC., 101 COLUMBIA ROAD, P O BOX 2245, MORRISTOWN, NJ, 07962-2245, US

(21) Appl. No.: 10/816,007

(22) Filed: Mar. 31, 2004

(51) Int. Cl. F16F 5/00

(52) U.S. Cl. 188/298

(57) ABSTRACT

A vibration and isolation apparatus is disclosed. The apparatus includes a fluid, a first fluid containment chamber, a second fluid containment chamber, and a damping path connecting the first fluid containment chamber and the second fluid containment chamber. The ratio of the cross sectional area of the first fluid containment chamber and the second fluid containment chamber to the cross sectional area of a damping path produces an effective mass of fluid for vibration isolation.

### TECHNICAL FIELD

This invention relates to the field of vibration damping and isolation. More specifically, the present invention pertains to a viscous isolation and damping strut utilizing a fluid mass effect.

### BACKGROUND

When transporting or operating a payload, such as a payload of sensitive equipment, it is often necessary to isolate and damp disturbances to the payload in order to avoid producing structural vibrations. Without isolation and damping, these structural vibrations may reduce the performance of the payload equipment or even result in permanent damage to the equipment. The need to isolate and damp vibrations on a payload is especially critical when the payload is on a spacecraft.

To overcome this problem, various damping and isolation systems have been utilized. For example, various forms of damping and isolation struts have been proposed. An example is the D-STRUT™ isolation strut, manufactured by Honeywell of Morristown, N.J. The D-STRUT™ isolation strut is a three-parameter vibration isolation system. That is, the D-STRUT™ isolation strut mechanically acts like a spring (K_{A}) in parallel with a series spring (K_{B}) and damper (C_{A}). A schematic of the mechanical structure of the D-STRUT™ isolation strut is illustrated in FIG. 1A. The D-STRUT™ isolation strut is the commercial embodiment of an isolation strut disclosed in U.S. Pat. No. 5,332,070 entitled “Three Parameter Viscous Damper and Isolator” by Davis et al. This patent is hereby incorporated by reference.

In a typical embodiment, multiple D-STRUT™ isolation struts are coupled at one end to a base, such as the floor or deck of a spacecraft, and are coupled at another end to a platform upon which the equipment to be isolated is attached, providing isolation and damping in multiple degrees-of-freedom.

The ability of an isolation system to isolate a payload and attenuate vibrations is described by the transmissibility transfer function. Transmissibility is the ratio of the output vibration over the input vibration (i.e., the vibration of the payload in relation to the vibration of the floor). Transmissibility varies as a function of the input vibration frequency. All structures have a natural frequency that is proportional to the stiffness and mass of the system. At this frequency, known as the resonant frequency, the isolation system does not attenuate vi, as the frequency of the vibrations increase, the amount of attenuation increases. The amount of the attenuation as the frequency increases is known as the roll-off and is measured in gain per decade of frequency. A decade of frequency is an order of magnitude change in frequency and gain is expressed in decibels (dB). Therefore, roll-off can be expresses in dB/decade. With a three-parameter system, like the D-STRUT™ isolation strut, a roll-off of 40 dB/decade can be achieved.

Three-parameter systems represent an improvement over previous designs such as two-parameter systems, which could typically only achieve a roll-off of −20 dB/decade. A mechanical schematic of a two parameter system is shown in FIG. 1B. As the need for increased attenuation grows due to increasingly sensitive and fragile payloads, it becomes necessary to look for isolation systems that can achieve greater roll-off than both the two and three parameter systems. It is also desirable to have a passive solution to avoid the increased complexity, cost, and risk associated with active systems.

Accordingly, it is desirable to design a four-parameter isolator that has increased roll-off. Other desirable features and characteristics of the present invention will become apparent from the subsequent detailed description and the appended claims, taken in conjunction with the accompanying drawings and the foregoing technical field and background.

### BRIEF SUMMARY

In one embodiment of the present invention, a vibration and isolation apparatus is disclosed. The apparatus includes a fluid, a first fluid containment chamber, a second fluid containment chamber, and a damping path connecting the first fluid containment chamber and the second fluid containment chamber. The ratio of the cross sectional area of the first fluid containment chamber and the second fluid containment chamber to the cross sectional area of a damping path is shown to produce an effective mass of fluid for vibration isolation.

In another embodiment of the present invention, a vibration damping and isolation apparatus implementing a four parameter system to provide improved isolation at high frequencies with similar amplification at the resonant frequency as a three parameter system is disclosed in accordance with the present invention. The apparatus comprises a shaft having an axis therethrough, with the shaft having a first and second end. A piston is coaxially positioned with the shaft to provide a damper by forming a damping path therebetween. The piston includes a flange extending radially from the piston for coupling the apparatus to a load. A first extension is coupled to and extends radially from the first end of the shaft and a second extension is coupled to and extends radially from the second end of the shaft. A secondary isolation means coaxially extends from the first and second extensions for providing a first volumetric stiffness in series with the damper. A primary isolation means connects the flange to the first extension and the second extension and is coaxial with the shaft to provide a second volumetric stiffness in parallel with the damper and the secondary isolation means. The secondary isolation means is connected to the primary isolation means via fluid paths through the first and second extensions. The ratio of a cross sectional area of the primary isolation means to a cross sectional area of the damping path, as well as the volume of the fluid cavity and therefore the actual mass of the fluid, are chosen to provide a fluid mass effect in series with the damper and first volumetric stiffness and in parallel with the second volumetric stiffness. The effective fluid mass provides a fourth parameter for the isolation system, which can lead to improved performance, as compared to the three parameter system.

In yet another embodiment of the present invention, an isolation and damping system is disclosed. The isolation and damping system comprises a platform for securing a payload and a plurality of isolation struts attached at one end to the platform and at a second end to a base. The mechanical equivalent of each of the plurality of isolation struts comprising four tunable parameters. The four tunable parameters comprise a first spring in parallel with a second spring, an effective fluid mass and a damper in series

### BRIEF DESCRIPTION OF THE DRAWINGS

The present invention will hereinafter be described in conjunction with the following drawing figures, wherein like numerals denote like elements, and

FIG. 1A is a mechanical schematic of a three-parameter isolation and damping system;

FIG. 1B is a mechanical schematic of a two-parameter isolation and damping system;

FIG. 2 is a top view of an exemplary viscous isolator;

FIG. 3 is a cross sectional view of the exemplary viscous isolator taken along line A-A;

FIG. 4 is a cross sectional view of the viscous isolator taken along line B-B;

FIG. 5 is a mechanical schematic of a four parameter isolator;

FIG. 6 is a transmissibility plot showing the fluid mass effect;

FIG. 7 is a simplified mechanical schematic of an exemplary isolator; and

FIG. 8 compares an example of three-parameter and four-parameter transmissibility transfer functions.

### DETAILED DESCRIPTION

The following detailed description is merely exemplary in nature and is not intended to limit the invention or the application and uses of the invention. Furthermore, there is no intention to be bound by any expressed or implied theory presented in the preceding technical field, background, brief summary or the following detailed description.

While the present invention is discusses with reference to an exemplary isolation strut, the teaching of the present invention is not limited to any one embodiment of isolation struts. Instead, the teachings of the present invention can be used in isolation struts of different design. In one embodiment, multiple isolation struts of the present invention may be coupled at one end to a platform designed to hold a payload and at another end to a base, such as the deck of a spacecraft, to form an isolation and damping system. While this is one exemplary use, the present invention can also be used in any situation when a fluid filled isolation strut is needed. Fluid, as used in the present invention, can be any viscous liquid or any gas known in the art. In the following descriptions, isolator and isolation strut can be used interchangeably.

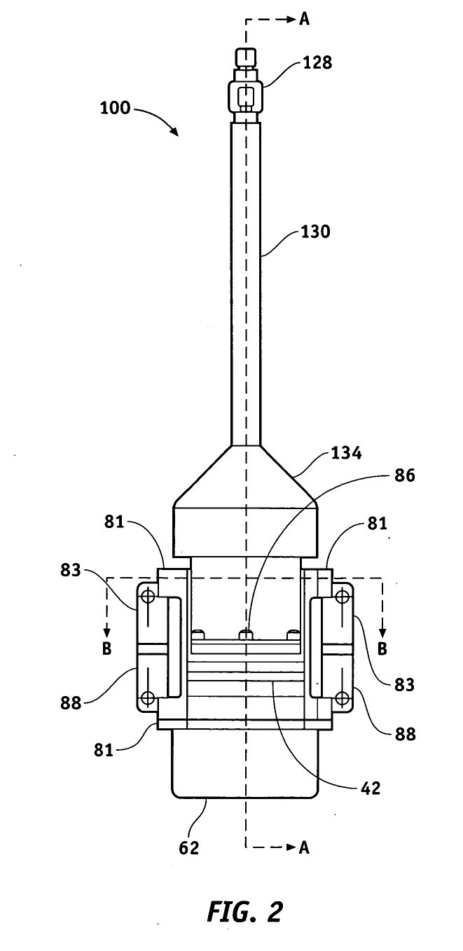

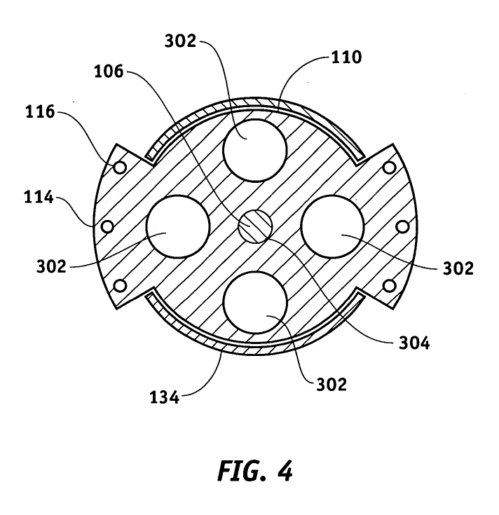

An exemplary isolator 100 in accordance with the present invention is described with reference to FIGS. 2-4. The description of this specific isolator 100 is for exemplary purposes only, as other isolator designs can utilize the teachings of the present invention. Isolator 100 isolates the payload from the source of the vibrations and attenuates vibrations that occur. Isolator 100 is in one embodiment, a passive isolator that utilizes a fluid to provide damping (remove energy). The principles of the present invention may also be utilized in an active system, which can utilize an actuator, such as a motor, to provide additional damping or to manipulate the parameters of an isolation strut (to “tune” the isolation strut).

The isolator 100 includes a shaft 102 having a central axis 104. Shaft 102 connects internal structures of the isolator 100 together such that any movement of these structures will be coupled. Shaft 102 connects a first extension 110 to a first shaft end 106 and connects a second extension 112 to a second shaft end 108.

First extension 110 and second extension 112 are of substantially the same design, both including a plurality of secondary fluid paths 302 which extend through first extension 110 and similarly through second extension 112. The first extension 110 also includes an opening 304 coaxial with axis 104 and sized to secure shaft end 106 therein. In addition, the first extension 110 includes a flange 114 for connection via hardware 116 to a base 118; such connection further described below. Again, second extension 112 includes similar structures.

Positioned coaxial with the shaft 102 is a piston 120. Piston 120 has an axial bore of a diameter greater than the diameter of the shaft 102, forming a fluid filled primary damping annulus 122 between the piston 120 and the shaft 102. Primary damping annulus 122 allows for the movement of the viscous fluid inside of isolator 100. A flange 126 extending radially outward from approximately a midsection of piston 120. The flange 126 couples an external load to the isolator 100. In the example of FIG. 2-4 a pivot flexure 128 couples to a tube 130 and the tube 130 couples to a cover 134. Cover 134 couples to flange 126 via hardware 86. Movement of the pivot flexure 128 results in movement of the tube 130 which moves the cover 134 which moves the flange 126 attached to the piston 120. The fluid internal to isolator 100 is sheared as it passes through the annulus and by the movement of the pistons 120 through the annulus, thus adding damping to this movement.

Isolator 100 further includes bellows which in one embodiment are defined as a liquid filled space and include a first primary bellows 138 and a second primary bellows 140. The flange 126 includes mating portions 145 for attaching one end of the first primary bellows 138 and one end of the second primary bellows 140. The second end of first primary bellows 138 and the second end of second primary bellows 140 couple to a mating portion 142 of first extension 110 and a mating portion 144 of second extension 112, respectively. The mating portions 142, 144, and 145 attach to the ends of the primary bellows 138 and 140 by a sealing material such as a welded joint, epoxy, or other adhesives insoluble in the chosen viscous medium. The bellows described herein may be constructed of nickel, a copper laminate, or any other suitable material and are currently available from Perkin-Elmer, of Wellesley, Mass. or Servometer Corporation, of Cedar Grove, N.J.

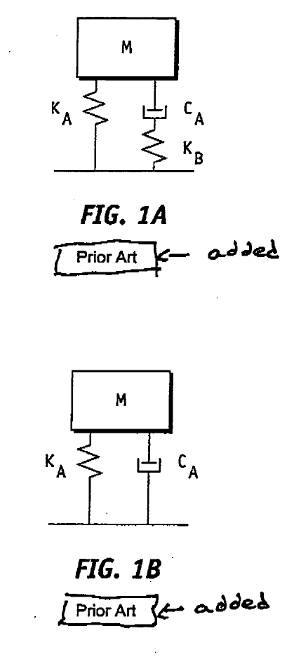

The second primary bellows 140 forms a second primary fluid chamber 148. The first and second primary fluid chambers 146 and 148 are connected via the fluid path of the primary damping annulus 122. The first and second primary bellows 138 and 140 substantially provides a stiffness, K_{A}, as shown in the mechanical schematic of the three parameter system of FIG. 1A. In alternate isolation strut designs, a mechanical spring can be used in parallel with the bellows to augment the K_{A} stiffness (generally used for stiffer designs where using only the axial stiffness of the bellows is not practical or feasible). A damper C_{A} is substantially provided by the shear forces of the incompressible fluid through the primary damping annulus 122 and the movement of the piston 120.

Isolator 100, in the exemplary embodiment shown in FIGS. 2-4, includes an additional pair of bellows; first secondary bellows 150 and second secondary bellows 152. First secondary bellows 150 is attached to a mating portion 142 of first extension 110 and to a first secondary sealing member 154 forming a first secondary fluid chamber 158. The first secondary fluid chamber 158 is coupled to first primary fluid chamber 146 by the secondary fluid path 143 which extends through the first extension 110. Likewise, the second secondary bellows 152 has a first end which is connected to a mating portion 144 of second extension 112 and a second secondary sealing member 156 to form a second secondary fluid chamber 160. The second secondary fluid chamber 160 is coupled to the second primary fluid chamber 148 via the secondary fluid path 147 through the second extension 112. The isolator 100 is further provided with a base 164 for coupling the isolator 100 to ground or an additional load.

Without the secondary bellows 150 and 152 present, the volumetric stiffness of the primary bellows 138 and 140 provides the stiffness K_{B}. The secondary bellows 150 and 152, while not needed to provide a stiffness K_{B} and which are not essential to the functionality of the design, can be used to tune K_{B} to a desired value. The addition of axial stiffness of the secondary bellows 150 and 152 provides a series stiffness to the volumetric stiffness of the primary bellows 138 and 140. With the secondary bellows 150 and 152 included, these series stiffnesses result in the stiffness K_{B}. In alternate isolation strut designs, the secondary bellows 150 and 152 can be replaced with any device capable of providing an axial stiffness in series with the primary bellows. For example, a mechanical spring could be used to provide an axial stiffness in series with the primary bellows, which can be used to tune K_{B} to a desired value.

Isolator 100 has no sliding or rubbing elements that might wear or cause Coulomb friction or stiction. The primary damping annulus 122 is continually maintained by positioning piston 120 a predetermined distance from shaft 102 and maintaining that distance through the connections of the shaft ends 106 and 108 to the first and second extensions 110 and 112, respectively, and connection of the flange 126 via the primary bellows 138 and 140 to the first and second extensions 110 and 112, respectively.

The functions of the isolator 100 are provided by the first and second primary bellows 138 and 140, the first and second secondary bellows 150 and 152, the first and second sealing members 154 and 156, the piston 120,; the shaft 102; the primary damping annulus 122, the plurality of secondary fluid paths 143 and 14, and the incompressible fluid contained within the isolator 100, all of which components are axially symmetric about axis 104. When a force is applied to the isolator 100, motion takes place between the shaft 102 and the piston 120 causing fluid to flow from one of the primary fluid chambers 146 and 148 to the other fluid chamber via the damping annulus 122. Fluid shear takes place in the primary damping annulus 122 providing system damping. Some fluid will also flow from the first and second primary fluid chambers 146 and 148 through the first and second secondary fluid paths 143 and 147 to the first and second secondary fluid chambers 158 and 160. The resistance to flow through the secondary fluid paths 143 and 147 is made small as compared to the primary damping annulus 122 to minimize damping by such secondary fluid paths 143 and 147.

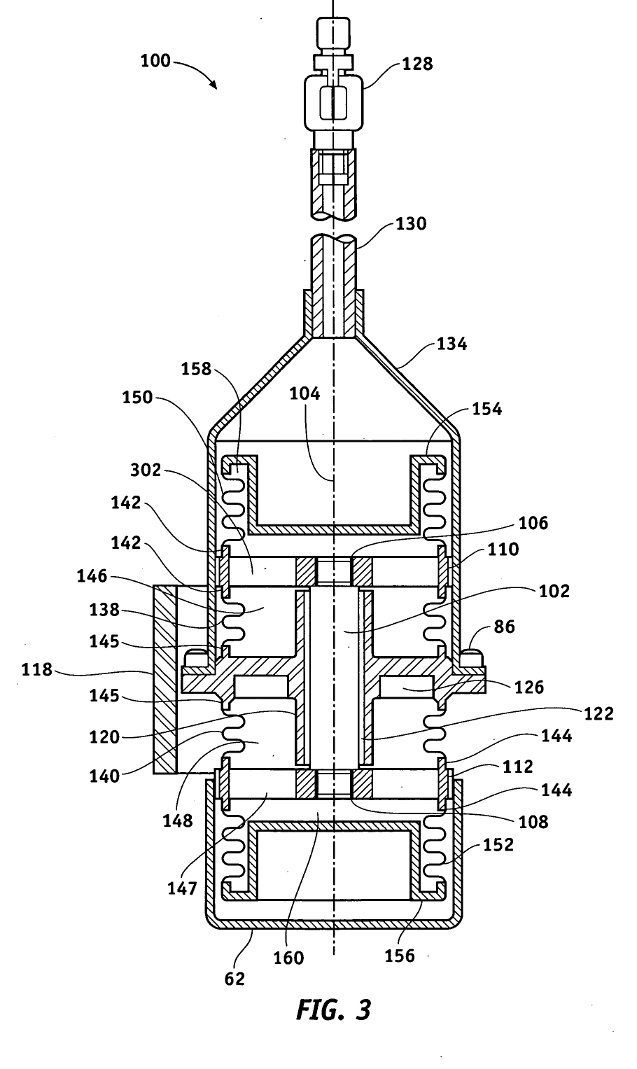

Both K_{A} and K_{B} can be varied by changing either the wall thickness of the bellows or the number of convolutions of the bellows. For example, in FIG. 3, the isolator 100, as illustrated, includes primary bellows having two convolutions and the secondary bellows 150, 152 having three convolutions. Likewise, an exemplary thickness, the wall of the primary bellows 138, 140 is about 0.00224 inches and the wall thickness of the secondary bellows 150, 152 is about 0.00276 inches. As will be recognized by one skilled in the art, such values can change depending on desired values of K_{A} and K_{B} and other design criteria.

Up to this point, the isolator 100, as described, is a three parameter system similar to that disclosed in U.S. Pat. No. 5,332,070. What has been ignored to this point is the effect that the mass of the fluid in the isolator 100 has on the system. Previous isolators either ignored the influence of the mass of the fluid inside the isolator 100 or designed isolators in which the fluid mass effect negligible.

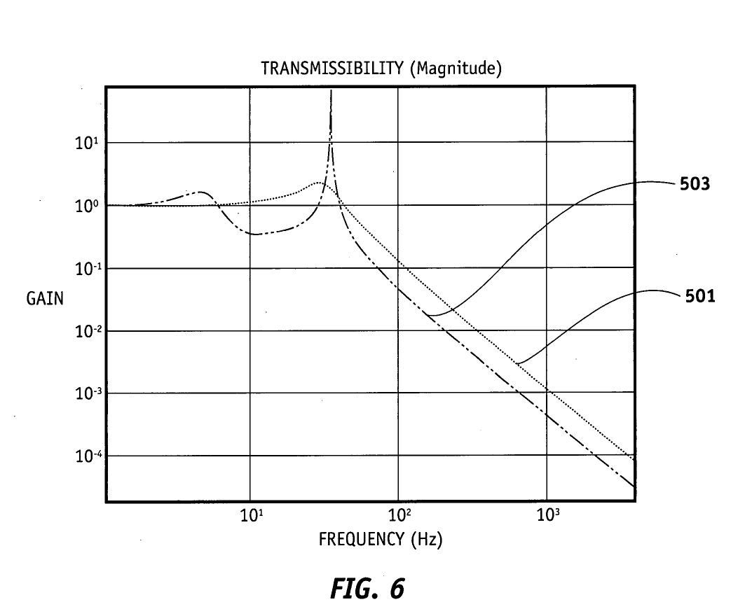

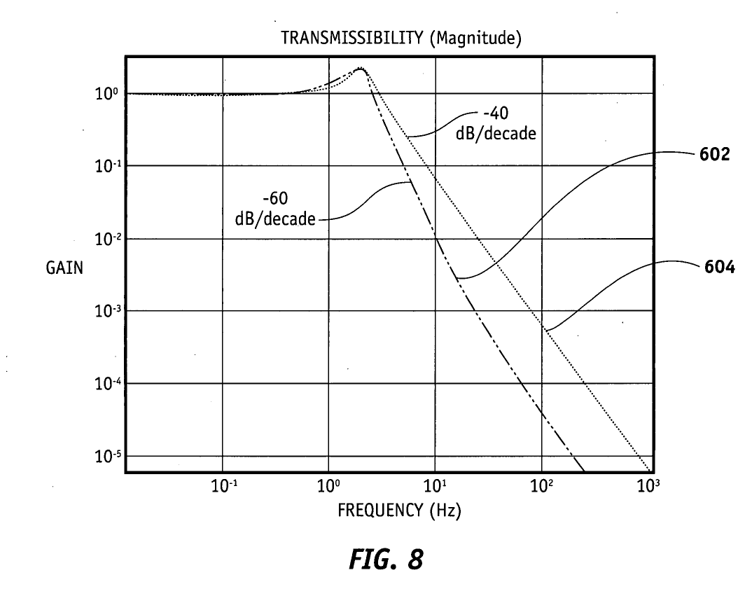

In prior art systems, it was not appreciated that the fluid mass effect could be used to enhance the performance of an isolator. What was known was that the presence of enough fluid mass can lead to non ideal three-parameter behavior. An example of a three-parameter system transmissibility without fluid mass, as well as one with the same three parameters with fluid mass is shown in FIG. 6, demonstrating the behavior. FIG. 6 demonstrates the shifting of resonant frequencies, the presence of more than one resonant peak, and the changes in amplification factor at resonance due to the fluid mass effect. In prior art isolators, these effects have been considered undesirable, as they corrupt the ideal three parameter transmissibility. A first curve 501 represents the transmissibility if there was no fluid mass effect. The first curve 501 illustrates a resonant frequency where there can be amplification and then a drop off showing attenuation at higher frequency. A second curve 503, in which the effective fluid mass is ten times the mass of the payload coupled to the isolator, shows two resonant areas with the second resonant area at a higher frequency than the for first curve 501. As the ratio of the effective fluid mass to the mass of the payload varies, the resultant transmissibility curve will shift. As discussed in greater detail below, the isolator can be designed to “tune” the fluid mass in, terms of the ration of effective fluid mass to payload mass. Depending on the characteristics desired by the designer, different ratios can be chosen. For example, in FIG. 8, discussed in greater detail below, a transmissibility curve for an exemplary isolator in accordance with the teachings of the present invention is illustrated. In this example, the isolator was designed to provide greater roll-off. In one embodiment, useful ratios of effective fluid mass to payload mass vary from where the ratio is one to one to where the effective fluid mass is greater than the payload mass. However, depending on the application, a designer of an isolator may choose to use an effective fluid mass that is less than the mass of the payload.

In the present invention, instead of trying to minimize and ignore the fluid mass effect, a four-parameter isolator is achieved by designing in the fluid mass effect to act as a “tunable parameter” along with K_{A}, K_{B}, and C_{A}. By tunable, various design parameters of isolator 100 can be varied to vary the beneficial effects of the fluid mass. In the present invention, the inclusion of the fluid mass in the isolator design can result in increased performance when the four parameters are all properly tuned, including an increased initial roll-off.

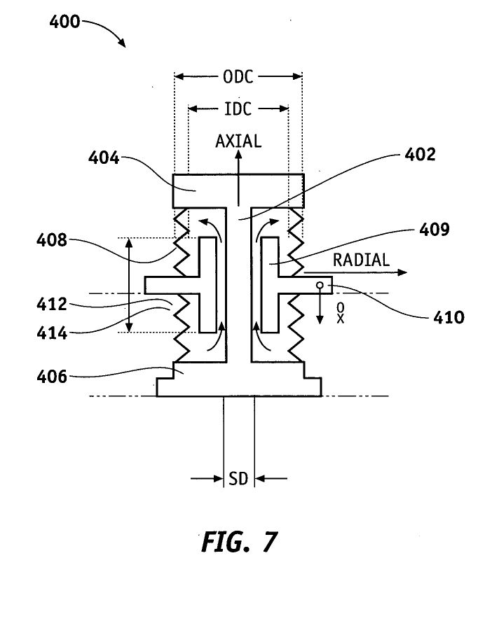

FIG. 7 illustrates a simplified cross section of an exemplary isolation strut 400, such as the one described in conjunction with FIG. 2-4. As before, the description of this specific isolation strut 400 is for exemplary purposes only, as other isolator designs can utilize the teachings of the present invention. Isolation strut 400 comprises a shaft 402 securing a top extension 404 and a bottom extension 406. Bellows 408 are secured between the top extension 404 and second extension 406, defining a first fluid containment area 405 and a second fluid containment area 407. The bellows 408, in one embodiment, have a circular cross section in the axial direction.

Isolation strut 400 further includes a piston 409 that is coaxial around the shaft 402. The piston 409 includes a flange 410 formed around the shaft 402. Movement of the flange 410 either axially or radially will move the piston 409 and the walls of the bellows 408 coupled to the flange 410 at the piston 409. The piston 409 can be a conventional piston or any other moveable component that responds similarly to a flange movement.

The effective mass of the fluid in the isolation strut 400 is proportional to the true mass of the fluid multiplied by the square of the ratio of the cross sectional area of the damping annulus (fluid path between the first fluid containment area 405 and the second fluid containment area 407) to the cross sectional area of the bellows:

$${M}_{effective} = {{M}_{true} ( \frac{{A}_{bellows}}{{A}_{annulus}} )}^{2}$$

To calculate the cross sectional area of the bellows, the diameter of the bellows must be determined. In the embodiment of FIG. 7, the cross sectional area of the bellows varies from a maximum where the cross section area is at the outermost convolute 412, to a minimum where the cross sectional area is taken at the innermost convolute 414. To determine the cross sectional area, the average diameter of the convolute (ADC) is calculated from the outer diameter of the convolute (ODC) (maximum diameter) and the inner diameter of the convolute (IDC) (minimum diameter):

$$ADC = \frac{IDC + ODC}{2}$$

The area of the bellows then can be calculated from the formula for the area of a circle (This is true if the cross section of the bellows is a circle, as it is in this example. If not, a different area formula would be used):

$${A}_{circle} = π {r}^{2} = \frac{π}{4} {d}^{2}$$

However, included within the bellows of the isolator is the cross sectional area of the shaft. The cross sectional area of the shaft must be subtracted from the area calculated using the ADC. The shaft, in this embodiment, is circular in cross section. If the diameter of the shaft is designated SD, the cross sectional area of the shaft is:

$${A}_{circle} = π {r}^{2} = \frac{π}{4} {d}^{2} = \frac{π}{4} {sd}^{2}$$

The result is the area of the bellows is:

$${A}_{bellows} = \frac{π}{4} ( {ADC}^{2} - {SD}^{2} )$$

The area of the damping annulus can be calculated as the area of the annular damping region, which is the area of the circular region having a diameter of the annular region, AD, as if there were no shaft, less the area of the shaft:

$${A}_{annulus} = \frac{π}{4} ( {AD}^{2} - {SD}^{2} )$$

Using the above relationships and the true mass of the fluid, the area of the bellows, shaft and/or annular region can be varied to change the effective mass. Since the ratio of the area of the bellows to the area of the annular region is squared, a small change in the ratio can cause a larger change in the effective mass. This is known as the amplification effect. The amplification provides the advantage of a large effective fluid mass when the actual true mass of the fluid is much smaller. Thus, less fluid can be used, which saves on weight and space.

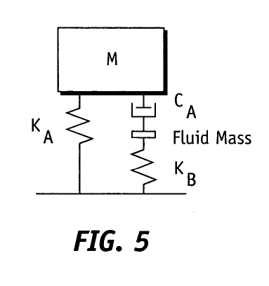

In an exemplary embodiment, the area of the bellows is 0.454 in², the area of the annular region is 0.0171 in² and the true mass of the fluid is 1.7806×10⁻⁶ snails, giving an effective mass of the fluid of 1.3×10⁻³ snails, where 1 snail=1 lb-sec²/in. In this embodiment the other parameters are: K_{A}=3.79 lb/in, K_{B}=130 lb/in and C_{A}=0.356 lb-s/in. Of course other designs would change the above parameters. A mechanical schematic of the four parameter system is shown in FIG. 5.

Another way to adjust the effective mass of a fluid is change the true mass by selecting a fluid with a different density. As density increases, the true mass will increase, assuming a constant volume. Also, by increasing the volume of fluid in the isolator, the effective mass of the fluid will increase.

The isolation apparatus described here is a passive device, where the areas calculated above are dependent upon the geometry of the hardware. It is possible that this geometry can be changed actively using an external actuator (such as a motor). An external actuator may be used to change the area of the bellows or the area of the annulus in the design described, thereby allowing active changes in the effective fluid mass.

An example of the obtainable performance of a four-parameter isolator is shown in FIG. 8. The plots of the transmissibility of the four-parameter isolator 602 and of the three-parameter system 604 are shown. At low frequency, both systems have a transmissibility of 1. After that, the transmissibility increases at a positive number until it reaches the peak, which is at the resonance frequency. After that peak, the transmissibility drops off (the roll-off). For the four parameter system, there are actually two resonant peaks in the transmissibility transfer function. When tuned properly, one of the resonances can be limited in amplitude to a very small number (almost disguising the presence of this resonance). The second resonance can be adjusted to be close to the traditional resonance seen in the three-parameter system. For the four-parameter system, the roll-off for the first decade of frequencies after the visible resonance is −60 dB/decade. The roll-off for the three-parameter system is −40 dB/decade. After the first decade after visible resonance, the roll-off of both systems is −40 dB/decade. Thus, when each of the four parameters are properly tuned, the four-parameter system represents an improvement over three-parameter systems for attenuating vibrations over certain frequency ranges.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing the exemplary embodiment or exemplary embodiments. It should be understood that various changes can be made in the function and arrangement of elements without departing from the scope of the invention as set forth in the appended claims and the legal equivalents thereof.

1. A vibration and isolation apparatus comprising:
a fluid having a true fluid mass, a density and a viscosity;
a first fluid containment chamber containing a first portion of the fluid;
a second containment chamber containing a second portion of the fluid;
an annular damping path connecting the first fluid containment chamber and the second fluid containment chamber and providing a fluid path between the first fluid containment chamber and the second fluid containment chamber; and
wherein the ratio of the cross sectional area of the first fluid containment chamber and the second fluid containment chamber to the cross sectional area of the annular damping path is chosen to produce an effective mass of the fluid to enhance vibration damping and isolation, the effective mass of the fluid greater than the true fluid mass.

2. The apparatus of claim 1 wherein the cross sectional area of the damping path can be changed to permit active tuning of the effective mass of the fluid.

3. The apparatus of claim 1 wherein the cross sectional area of the first fluid containment chamber or the second fluid containment chamber can be varied to permit active tuning of the effective mass of the fluid.

4. The apparatus of claim 1 wherein the apparatus supports a payload having a fixed mass.

5. The apparatus of claim 4 wherein the true mass of the fluid is less than the mass of the payload and the effective mass of the fluid is greater than or equal to the mass of the payload.

6. The apparatus of claim 1 wherein the effective fluid mass of the fluid is chosen to give the apparatus a roll-off of −60 dB per decade for at least one decade after a significant resonance.

7. The apparatus of claim 1 wherein the density of the fluid can be changed to change the effective fluid mass.

8. A fluid filled isolator for vibration damping and isolation, the mechanical equivalent of the isolator comprising four tunable parameters and wherein the four tunable parameters comprising a first spring in parallel with a second spring, an effective fluid mass, the effective fluid mass based on a ratio of a cross sectional area of a first fluid containment chamber and a second fluid containment chamber to a cross sectional area of an annular damping path, and a first damper in series.

9. The isolator of claim 8 wherein the effective fluid mass is equal to the true fluid mass multiplied by an amplification factor.

10. The isolator of claim 9 wherein the true fluid mass is less tan a mass of a payload coupled to the isolator and the effective mass is equal to or greater than the mass of the payload.

11. The isolator of claim 10 wherein the first spring force is formed by a stiffness formed by the design of a first fluid chamber and a second fluid chamber.

12. The isolator of claim 11 wherein the damper is substantially provided by the shear force of the fluid through a damping annulus located between the first fluid chamber and the second fluid chamber.

13. The isolator of claim 12 wherein the second spring force is formed from a volumetric stiffness of the first fluid containment chamber and the second fluid containment chamber and axial stiffness coupled to the first fluid containment chamber and the second fluid containment chamber.

14. The isolator of claim 13 wherein the effective fluid mass is proportional to the ratio of the cross sectional area of the first fluid containment chamber and the second fluid containment chamber divided by the cross sectional area of the damping annulus, the quantity squared.

15. The isolator of claim 8 wherein the effective fluid mass to payload mass is chosen to provide a roll-off −60 dB per decade for at least one decade after a significant resonance.

16. A fluid filled damping and isolation apparatus, comprising:
a shaft having an axis therethrough, the shaft having a first and second end;
a piston having an axial bore coaxially positioned with the shalt to provide a damper by forming a damping path therebetween, the piston having a flange extending radially therefrom for coupling the apparatus to a load;
a first extension coupled to and extending radially from the first end of the shaft;
a second extension coupled to and extending radially from the second end of the shaft;
secondary isolation means coaxially extending from the first and second extensions for providing a first volumetric stiffness in series with the damper;
primary isolation means connecting the flange to the first extension and the second extension and coaxial with the shaft for providing a second volumetric stiffness in parallel with the damper and the secondary isolation means, the secondary isolation means connected to the primary isolation means via fluid paths through the first and second extensions; and
wherein the ratio of a cross sectional area of the primary isolations means to a cross sectional area of the damping path are chosen to provide a fluid mass effect, the fluid mass effect determined by an effective mass of the fluid, the effective mass of the fluid greater than a true fluid mass.

17. The apparatus of claim 16 wherein the cross sectional area of the primary isolation means can be varied to permit active tuning of the fluid mass effect.

18. The apparatus of claim 16 wherein the cross sectional area of the damping path can be changed to permit active tuning of the fluid mass effect.

19. The apparatus of claim 16 wherein the fluid mass effect is chosen to give the apparatus a roll-off of −60 dB per decade for at least one decade after a significant resonance.

20. The apparatus of claim 16 wherein the fluid mass effect can be change by varying the mass of a fluid internal to the apparatus.

21. An isolation and vibration damping system comprising:
a platform for securing a payload; and
a plurality of isolation struts attached at one end to the platform and at a second end to a base, the mechanical equivalent of each of the plurality of isolation struts comprising four tunable parameters, the four tunable parameters comprising a first spring in parallel with a second spring, an effective fluid mass the effective fluid mass based on a ratio of a cross sectional area of a first fluid containment chamber and a second fluid containment chamber to a cross sectional area of an annular damping path and a damper in series.

22. The system of claim 21 wherein the first spring force is formed by a stiffness formed by the design of a first fluid chamber and a second fluid chamber.

23. The system of claim 22 wherein the damper is substantially provided by a shear force of a fluid through a damping annulus located between the first fluid chamber and the second fluid chamber.

24. The system of claim 23 wherein the second spring force is formed from a volumetric stiffness of the first fluid containment chamber and the second fluid containment chamber and axial stiffness coupled to the first fluid containment chamber and the second fluid containment chamber.

25. The system of claim 24 wherein the effective fluid mass is proportional to the ratio of the cross sectional area of the first fluid containment chamber and the second fluid containment chamber divided by the cross sectional area of the damping annulus, the quantity squared
